(19) United States
(12) Patent Application Publication
(10) Pub. No.: US 2018/0018569 A1
(43) Pub. Date: Jan. 18, 2018

(54) Mutual Reinforcement of Collaborative Filtering and Sentiment Analysis

(71) Applicant: International Business Machines Corporation, Armonk, NY (US)

(72) Inventors: Haggai Roitman, Yoknea'm Elit (IL); Oren Sar-Shalom, Nes Ziona (IL)

(21) Appl. No.: 15/207,523

(22) Filed: Jul. 12, 2016

(51) Int. Cl. G06N 5/04; G06N 99/00; G06F 17/30

(52) U.S. Cl. CPC G06N 5/04; G06F 17/30867; G06N 99/005

(57) ABSTRACT

Methods, computing systems and computer program products implement embodiments of the present invention that include identifying a set of the items in the transactions, and executing, using input including the transactions, an implicit feedback collaborative filtering model to compute, for each of the users, a predicted rating for each of the items. Using input including the transactions and the predicted ratings as labels, a sentiment analysis model is executed to compute, for each given user, an opinion for each of the given items in the transactions for the given user, and using input including the transactions and the opinions as factors for the predicted ratings, an explicit feedback collaborative analysis model is executed to update, for each of the users, the predicted ratings for each of the items.

### FIELD OF THE INVENTION

The present invention relates generally to data analysis, and specifically to using output from a collaborative filtering model to train a sentiment analysis model, and using output from the sentiment analysis model to train the collaborative filtering model.

### BACKGROUND

Collaborative filtering and sentiment analysis are two techniques commonly used to analyze large datasets storing user activities such as purchase histories or content viewing histories. In collaborative filtering, predictions are made about interests of a user by collecting preferences or taste information from many users. An underlying assumption of collaborative filtering is that if a first person has the same opinion as a second person on some issues, they are more likely to have the same opinions on other issues. In sentiment analysis, the objective is to determine an attitude of a user (e.g., a speaker or a writer) with respect to some topic or overall contextual polarity of a text attributed to the user.

The description above is presented as a general overview of related art in this field and should not be construed as an admission that any of the information it contains constitutes prior art against the present patent application.

### SUMMARY

There is provided, in accordance with an embodiment of the present invention a method, including receiving a set of transactions for multiple users, each of the transactions including a user, an item, and a text string indicating an attitude of the given user toward the item, identifying a set of the items in the transactions, executing, using input including the transactions, an implicit feedback collaborative filtering model to compute, for each of the users, a predicted rating for each of the items, executing, using input including the transactions and the predicted ratings as labels, a sentiment analysis model to compute, for each given user, an opinion for each of the given items in the transactions for the given user, and executing, using input including the transactions and the opinions as factors for the predicted ratings, an explicit feedback collaborative analysis model to update, for each of the users, the predicted ratings for each of the items.

There is also provided, in accordance with an embodiment of the present invention an apparatus, including a memory configured to store an implicit feedback collaborative filtering model, a sentiment analysis model and an explicit feedback collaborative filtering model, and a processor configured to receive a set of transactions for multiple users, each of the transactions including a user, an item, and a text string indicating an attitude of the user toward the item, to identify a set of the items in the transactions, to execute, using input including the transactions, the implicit feedback collaborative filtering model to compute, for each of the users, a predicted rating for each of the items, to execute, using input including the transactions and the predicted ratings as labels, the sentiment analysis model to compute, for each given user, an opinion for each of the given items in the transactions for the given user, and to execute, using input including the transactions and the opinions as factors for the predicted ratings, the explicit feedback collaborative analysis model to update, for each of the users, the predicted ratings for each of the items.

There is further provided, in accordance with an embodiment of the present invention a computer program product, the computer program product including a non-transitory computer readable storage medium having computer readable program code embodied therewith, the computer readable program code including computer readable program code configured to receive a set of transactions for multiple users, each of the transactions including a user, an item, and a text string indicating an attitude of the user toward the item, computer readable program code configured to identify a set of the items in the transactions, computer readable program code configured to execute, using input including the transactions, an implicit feedback collaborative filtering model to compute, for each of the users, a predicted rating for each of the items, computer readable program code configured to execute, using input including the transactions and the predicted ratings as labels, a sentiment analysis model to compute, for each given user, an opinion for each of the given items in the transactions for the given user, and computer readable program code configured to execute, using input including the transactions and the opinions as factors for the predicted ratings, an explicit feedback collaborative analysis model to update, for each of the users, the predicted ratings for each of the items.

### BRIEF DESCRIPTION OF THE DRAWINGS

The disclosure is herein described, by way of example only, with reference to the accompanying drawings, wherein:

FIG. 1 is a block diagram that schematically illustrates a computer configured to mutually reinforce a sentiment analysis model and a collaborative filtering model, in accordance with an embodiment of the present invention;

FIG. 2 is a block diagram that schematically illustrates a dataflow for the mutual reinforcement of the sentiment analysis model and the collaborative filtering model, in accordance with an embodiment of the present invention; and

FIG. 3 is a flow diagram that schematically illustrates a method of mutually reinforcing collaborative filtering and sentiment analysis models, in accordance with an embodiment of the preset invention.

### DETAILED DESCRIPTION OF EMBODIMENTS

Sentiment analysis algorithms typically require labeled data of the same domain that they will analyzing in order to generate accurate predictions. Embodiments of the present invention provide methods and systems for creating mutual reinforcement of collaborative filtering and sentiment analysis by using output from a collaborative filtering model to train a sentiment analysis model and using output from the sentiment analysis model to train the collaborative filtering model, thereby improving the accuracy of both of the models without requiring any labeled data. As described hereinbelow, a set of transactions is received, each of the transactions comprising a user, an item, and a text string indicating an attitude of the user toward the given item. Upon receiving the set of transactions, a set of the items in the transactions is identified.

Using input comprising the transactions, an implicit feedback collaborative filtering model is executed to compute, for each of the users, a predicted rating for each of the items, and using input comprising the transactions and the predicted ratings as labels, a sentiment analysis model is executed to compute, for each given user, an opinion for each of the given items in the transactions for the given user. Finally, using input comprising the transactions and the opinions as factors for the predicted ratings, an explicit feedback collaborative analysis model is executed to update, for each of the users, the predicted ratings for each of the items.

In embodiments of the present invention, the set of transactions comprises training data, the predicted ratings can be used as labels to train the sentiment analysis model, and the opinions used can be used to train the explicit collaborative feedback model. In some embodiments, the training of the models may comprise repeating the steps of executing the sentiment analysis model and executing the explicit feedback collaborative filtering model until the opinions and the predicted ratings reach respective stable states. Upon completing the training of the models, production data comprising an additional set of transaction data for one or more users can be received, and the trained models can be used to generate opinions and/or ratings for the production data, wherein the users in the production data may (or may not) differ from the users in the training data.

Computer systems implementing embodiments of the present invention can alternatively set the output of the collaborative filtering model as the label set for the sentiment classifier, and set the output of the sentiment classifier as the label for the collaborative filtering model. Additionally, by supplying labels for the sentiment analysis model, systems implementing embodiments enable sentiment analysis models to effectively operate in a “supervised” mode without the use of labeled data. Advantages of systems implementing embodiments of the present invention include:
Using the collaborative filtering model to train a sentiment analysis model without any labeled data.
Using the sentiment analysis model to improve the accuracy of the collaborative filtering model.
An ability to use any collaborative filtering algorithm in the collaborative filtering model and to use any sentiment analysis algorithm in the sentiment analysis model. Examples of collaborative filtering algorithm types include neighborhood-based algorithms, user-based algorithms and model-based algorithms, and examples of sentiment analysis algorithms include deep learning and parse-tree based algorithms for sentiment analysis.

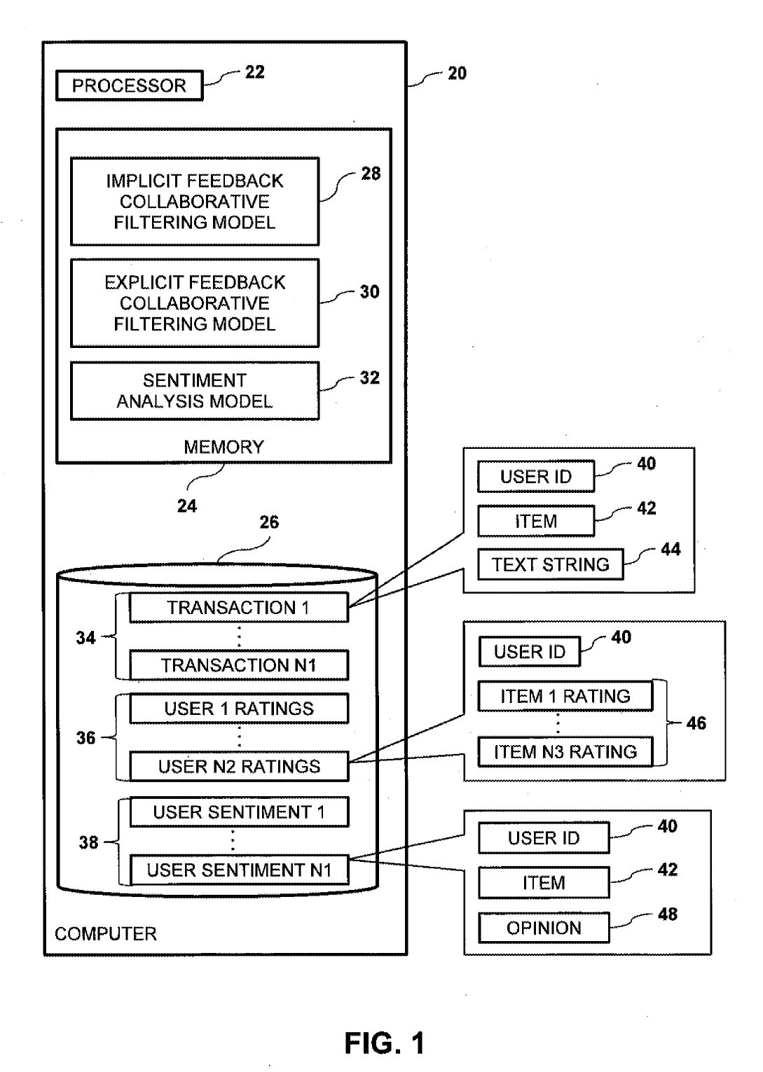

FIG. 1 is a block diagram that schematically illustrates a computer 20 comprising a processor 22, a memory 24, and a storage device 26. Examples of memory 24 include dynamic random-access memory and non-volatile random-access memory, and examples of storage device 26 include hard disk drives and solid-state disk drives.

In embodiments described herein, processor 22 executes, from memory 24, an implicit feedback collaborative filtering model 28, an explicit filtering collaborative filtering model 30, and a sentiment analysis model 32. The difference between the implicit feedback and the explicit feedback collaborative filtering models is explained hereinbelow.

Storage device 26 stores transactions 34, user ratings 36 and user sentiments 38. The transactions are used as input data for models 28, 30 and 32, and comprise a set of user identifiers (IDs) 40 that “interact” with a set of items 42. Each transaction 34 comprises a given user ID 40, a given item 42 with which the given user has had an interaction (e.g., purchased by the given user), and a text string 44 that comprises the given user's comments on the given item.

The user IDs reference respective users (e.g., customers), and in embodiments described herein the terms user ID and user refer to individual and are therefore may be used interchangeably. For a given transaction 34 comprising a given user ID 40, a given item 42 and a given text string 44, the given text string comprises a “review” that indicates the given user's attitude toward the given item. For example, if the items comprise movies and the text given text string comprises “this movie was exciting”, then the given text string indicates a positive attitude. Likewise, if the given text string comprises “this movie was boring”, then the given text string indicates a negative attitude.

In a first example, transactions 34 may be from an on-line retailer, wherein each of the transactions comprises a given item 42 that a given user ID 40 has interacted with via a transaction such as a purchase. In a second example, transactions 34 may be from an on-line media provider (e.g., a movie streaming service or a music streaming service), wherein each of the items comprises a media title (e.g., a movie or a music track) and each of the transactions comprises a given item 42 that a given user ID 40 has interacted with by “playing” the given item. In a third example, transactions 34 may be from a service provider such as a hotel or restaurant, wherein each of the transactions comprises a given item 42 (e.g., a meal or a stay in a hotel room) that a given user ID 40 has purchased from the service provider.

As described hereinbelow, implicit feedback collaborative filtering model 28 generates user ratings 36 in response to analyzing transactions 34, sentiment analysis model 32 generates user sentiments 38 in response to analyzing the user ratings and the transactions, and explicit feedback collaborative feedback model 30 generates the user ratings 36 in response to analyzing the transactions and the user sentiments. In operation, each given user ID 40 corresponds to a single user rating 36, wherein each of the user ratings comprises a given user ID 40 and respective item ratings 46 (typically mathematical scores) for each of the items in the set of items 42.

For example, if there are 1,000 user IDs 40 and 100 items 42, models 28 and 30 will generate 1,000 user ratings 36, wherein each of the user ratings comprises 100 item ratings 46. In embodiments of the present invention, for each of the user IDs, models 28 and generate respective item ratings 46 for each of the items, regardless of whether or not a given user ID 40 has interacted with (e.g., purchased) a given item 42.

Each of the user sentiments generated by sentiment analysis model 32 comprises a given user ID 40, a given item 42 and a given opinion 48 (typically a mathematical score). Therefore, there is a one-to-one correspondence between transactions 34 and user sentiments 38, wherein sentiment analysis model 32 uses a given transaction 34 and a given user rating 36 to generate a given opinion 48 using embodiment described hereinbelow.

Processor 22 comprises a general-purpose central processing units (CPU) or special-purpose embedded processors, which are programmed in software or firmware to carry out the functions described herein. The software may be downloaded to computer 20 in electronic form, over a network, for example, or it may be provided on non-transitory tangible media, such as optical, magnetic or electronic memory media. Alternatively, some or all of the functions of processor 22 may be carried out by dedicated or programmable digital hardware components, or using a combination of hardware and software elements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Feedback-Based Collaborative Filtering and Sentiment Analysis

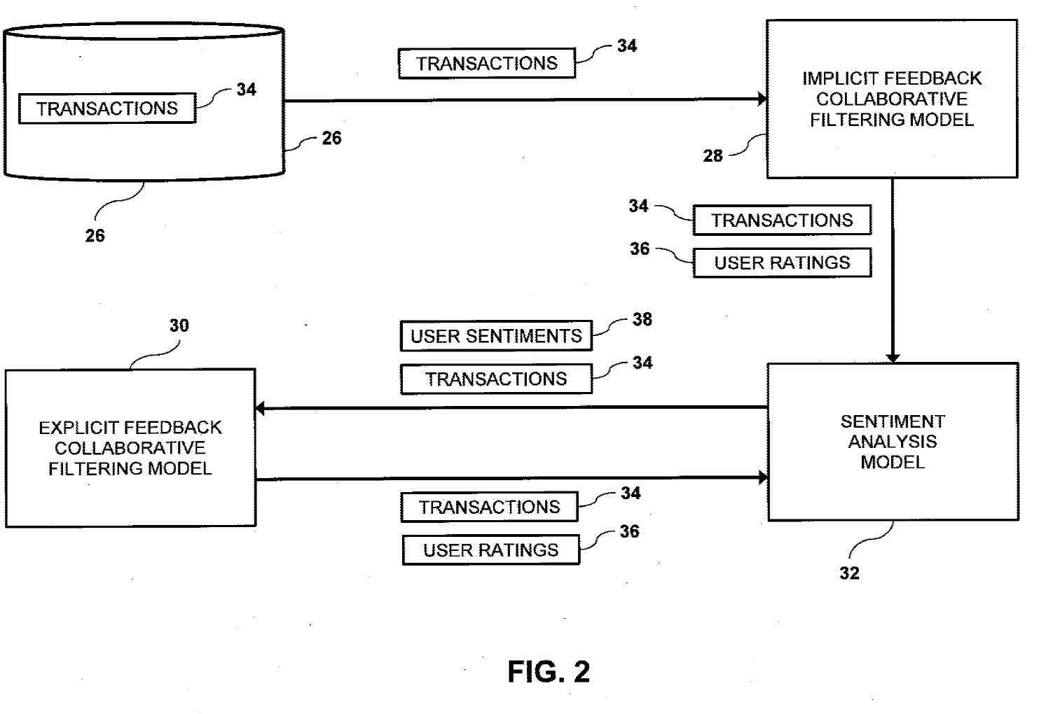

FIG. 2 is a block that schematically illustrates mutual reinforcement of sentiment analysis model 32 and explicit feedback collaborative filtering model 30, in accordance with an embodiment of the present invention. In the block diagram shown in FIG. 2, models 28, 30 and 32 use transactions 34 as input data, wherein each of the transactions comprises a given user ID 40, a given item 42, and a text string 44.

For a given transaction 34 comprising a given user ID 40, a given item 42 and a given text string 44, the text given string comprises input from the given user expressing a review of the given item. Formally, the input data belongs to U×I×T, where U, I and T denote the user IDs, the items and the text strings, respectively. For example, the text strings in transactions 34 may comprise hotel reviews, wherein each of the reviews is associated with the user ID who wrote the review and the reviewed hotel.

In embodiments of the present invention, if model 30 strongly recommends a given item 42 for a given user id 40, then opinion 48 of the given user towards the given item should be greater than an average of the opinions for the given item. Additionally, the text string that a given user 40 wrote indicates a positive review for the given item, the explicit feedback collaborative filtering model should have recommended this given item for the given user.

In embodiments of the present invention, implicit feedback collaborative filtering model 28 is trained to generate predicted item ratings 46. In some embodiments, implicit feedback collaborative filtering model 28 can generate the predicted item ratings by ignoring text strings 44 and only considering the historical list of pairs of user IDs 40 and items 42 (also referred to herein as user-item pairs). Alternatively, collaborative filtering model 28 can use algorithms that incorporate analysis of text strings 44 to generate predicted item ratings 46.

Once trained, implicit feedback collaborative filtering model 28 can supply recommendations to any user-item pair by generating item ratings 46 (i.e., recommendation scores) for items 42 that were in the transactions of users 40. The ratings on those items should not be biased from the actual usage. Therefore, to eliminate this bias, to obtain a “recommendation” for a given user ID 40 and a given item 42, a new user ID 40 can be input to implicit feedback collaborative filtering model 28 to the system, who have the same transaction history as the given (i.e., existing) user, but without the given item. Implicit feedback collaborative filtering model 28 can then generate a recommendation for the new user and the given item. In order to eliminate overfitting, cross validation can be used.

In embodiments of the present invention, the user ratings generated by implicit feedback collaborative filtering model 28 can be considered as “noisy labels” (i.e., labels with classification noise) for sentiment analysis model 32. While sentiment analysis model 32 may use external data such as sentiment lexicon and data from transactions 34, the sentiment analysis model still needs labels as part of the training process. In the data flow shown in FIG. 2, implicit feedback collaborative filtering model 28 conveys the user ratings (i.e., the noisy labels) to sentiment analysis model 32.

In the data flow shown in FIG. 2, sentiment analysis model 32 generates user sentiments 38, and conveys the user sentiments and the data in transactions 34 to explicit feedback collaborative filtering model 30. In embodiments of the present invention, setting the output of the sentiment classifier model as a label set for explicit feedback collaborative filtering model 30 can improve the performance of the explicit feedback collaborative filtering model. This is due to the fact that while to explicit feedback collaborative filtering model 30 is initially “aware” of the existence of a given user-item pair (i.e., via transactions 34), adding user sentiments 38 as input enables model 30 enables the explicit feedback collaborative filtering model to determine whether or not the user “liked” a given item 42. Likewise, setting the output (i.e., user ratings 36) of the explicit feedback collaborative filtering model as the label set (i.e., an input) for the sentiment analysis model can enable the sentiment analysis model to more accurately calculate opinions 48.

Therefore, the next phase in embodiments of the present invention is to alternately improve both the explicit feedback collaborative filtering model and the sentiment analysis model until they “converge”. This can be performed by setting the output of one of models 30 and 32 as the label set of the other. In embodiments described herein models 30 and 32 converge when their respective outputs stabilize (i.e., reach a stable state by changing little between iterations).

In some embodiments, a requirement from both models 30 and 32 is to supply confidence scores to their predictions on a [0-1] scale. However, if the models do not supply a confidence level, a fixed confidence (e.g., 0.5) can be taken. Typically every algorithm for model 30 can supply a confidence score by applying a function such as tan h(/u/) on the number of items 42 in the history of the user, where /u/ denotes the number of the items in the history of u. This confidence score implies to what extent the “noisy label” is correct and can improve the learning phase.

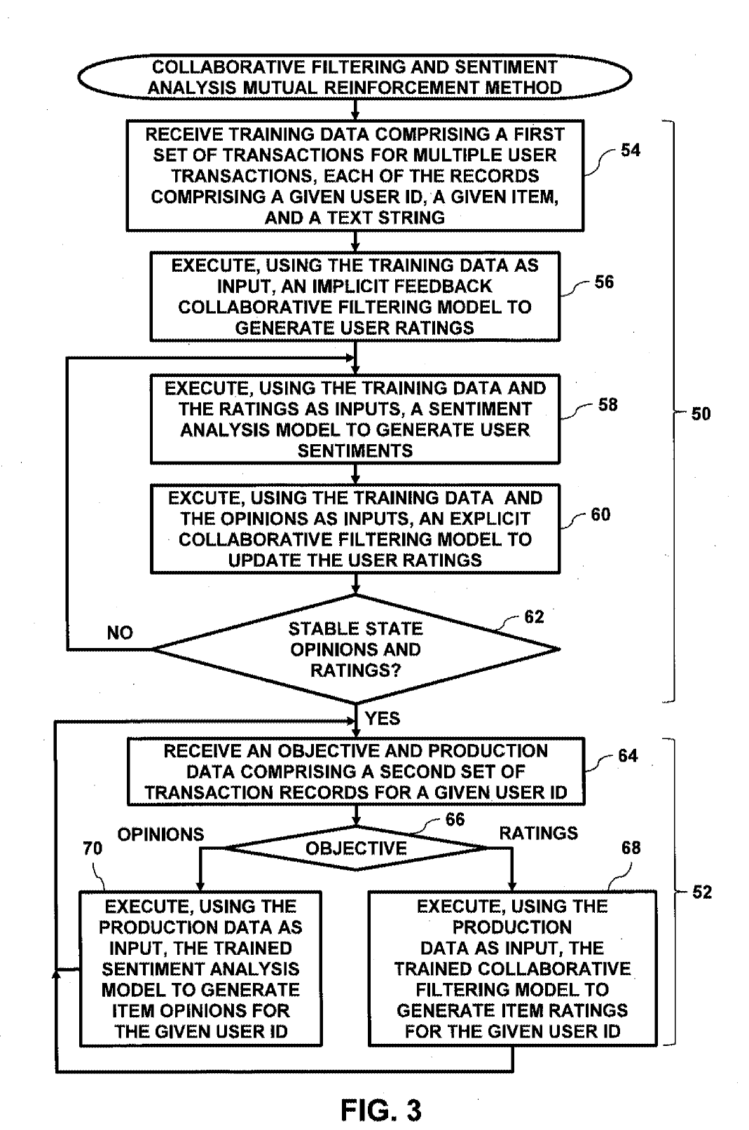

FIG. 3 is a flow diagram that schematically illustrates a method of implementing a mutual reinforcing collaborative sentiment and collaborative filtering analysis, in accordance with an embodiment of the present invention. The flow diagram in FIG. 4 comprises a training mode 50 comprising steps 54-62 and a production mode 52 comprising steps 64-70.

In a first receiving step 54, processor 22 receives training data comprising first set of transactions 34, and in a first execution step 56, the processor executes, using the first set of transactions as input, implicit collaborative filtering model 28 to generate user ratings 36. As described supra, embodiments of the present invention can use the user ratings generated by implicit collaborative filtering model 28 as “noisy labels” in order to train sentiment analysis model 32. In some embodiments, processor 22 identifies a set comprising all the items in transactions 34.

In a second execution step 58, processor 22 executes, using the first set of transactions 34 and user ratings 36 as input, a sentiment analysis model to generate user sentiments 38, and in a third execution step 60, the processor executes, using the first set of transactions 34 and user sentiments 38 as input, an explicit feedback collaborative filtering model 30 to update user ratings 36. In embodiments of the present invention, processor 22 repeats steps 58 and 60 (note that processor 22 updates user sentiments 38 when repeating step 58) until user ratings 36 and user sentiments reach a “stable state”. In embodiments of the present invention, change thresholds for the user ratings and the user sentiments are specified, and the stable state is reached when upon repeating steps 58 and 60, the changes to user ratings 36 and user sentiments 38 are within their respective change thresholds.

In a comparison step 62, if there is no stable state for user ratings 36 and user sentiments 38, then the method continues with step 58. In embodiments of the present invention, processor 22 trains sentiment analysis model 32 while performing step 58 and trains explicit feedback collaborative filtering model 30 while performing step 60. In other words, explicit feedback collaborative filtering model 30 analyzes opinions 48 when generating item ratings 46, and sentiment analysis model 32 analyzes item ratings 46 when generating opinions 48. When the stable state for user ratings 36 and user sentiments 38 is reached, training mode 50 is complete (i.e., models 30 and 32 are trained), and processor 22 can now analyze additional transactions 34 in production mode 52.

In a second receiving step 64, processor 22 receives an objective and production data comprising an additional set of transactions 34 for a given user ID 40. The received given user ID may comprise an existing user ID 40 in the first set of transactions 40, or may comprise a new user ID 40.

In a an objective step 66, if the received (i.e., requested) objective is user ratings 36, then in a fourth execution step 68, processor 22 executes, using the second set of transactions 34 as input, the “trained” explicit feedback collaborative filtering model to generate a given user sentiment (i.e., a set of item ratings 46) for the given user ID, and the method continues with step 64. Returning to step 66, of the received objective is user sentiments 38, then in a fifth execution step 70, processor 22 executes, using the second set of transactions 34 as input, the “trained” sentiment analysis model to generate user sentiments 38 for the items in the transactions of the given user, and the method continues with step 64.

In some embodiments, processor 22 may skip step 56 and skip executing implicit feedback collaborative filtering model 28 during the training mode. If processor 22 starts the training mode by executing sentiment analysis model 32, the sentiment analysis model can use a transfer learning algorithm to use labeled data from a different domain. In an alternative embodiment, sentiment analysis model 32 can be configured to generate user sentiments 38 without having any labels for transactions 34. In the alternative embodiment, processor 22 can first execute sentiment analysis 32 during the training mode, and then train explicit feedback collaborative filtering model 30 to generate (explicit) item ratings 36.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
receiving a set of transactions for multiple users, each of the transactions comprising a user, an item, and a text string indicating an attitude of the given user toward the item;
identifying a set of the items in the transactions;
executing, using input comprising the transactions, an implicit feedback collaborative filtering model to compute, for each of the users, a predicted rating for each of the items;
executing, using input comprising the transactions and the predicted ratings as labels, a sentiment analysis model to compute, for each given user, an opinion for each of the given items in the transactions for the given user; and
executing, using input comprising the transactions and the opinions as factors for the predicted ratings, an explicit feedback collaborative analysis model to update, for each of the users, the predicted ratings for each of the items.

2. The method according to claim 1, wherein using the predicted ratings as the labels trains the sentiment analysis model, and wherein using the opinions as factors trains the explicit collaborative feedback model.

3. The method according to claim 2, and further comprising repeating the steps of executing the sentiment analysis model and executing the explicit feedback collaborative filtering model until the opinions and the predicted ratings reach respective stable states.

4. The method according to claim 2, wherein the transactions comprise first transactions, wherein the users comprise first users, wherein the items comprise first items, wherein the text strings comprise first text strings, wherein the opinions comprise first opinions, and further comprising receiving second transactions for a second user and a request for second opinions, each of the second transactions comprising the second user, a second item, and a second text string indicating an attitude of the second user about the second item, and executing, using input comprising the second transactions, the trained sentiment analysis model to compute, in response to the request, a second opinion for each of the second items in the second transactions for the second user.

5. The method according to claim 2, wherein the transactions comprise first transactions, wherein the users comprise first users, wherein the items comprise first items, wherein the text strings comprise first text strings, wherein the predicted ratings comprise first predicted ratings, and further comprising receiving second transactions for a second user and a request for second predicted ratings, each of the second transactions comprising the second user, a second item, and a second text string indicating an attitude of the second user about the second item, and executing, using input comprising the second transactions, the trained explicit feedback collaborative analysis model to compute, in response to the request, respective second predicted ratings for each of the second items in the second transactions for the second user.

6. The method according to claim 1, and further comprising skipping the performing of the implicit feedback collaborative filtering model, computing, using a transfer learning algorithm, the labels for each of the text strings, and conveying the labels to the sentiment analysis.

7. An apparatus, comprising:
a memory configured to store an implicit feedback collaborative filtering model, a sentiment analysis model and an explicit feedback collaborative filtering model; and
a processor configured to:
to receive a set of transactions for multiple users, each of the transactions comprising a user, an item, and a text string indicating an attitude of the user toward the item,
to identify a set of the items in the transactions,
to execute, using input comprising the transactions, the implicit feedback collaborative filtering model to compute, for each of the users, a predicted rating for each of the items,
to execute, using input comprising the transactions and the predicted ratings as labels, the sentiment analysis model to compute, for each given user, an opinion for each of the given items in the transactions for the given user, and
to execute, using input comprising the transactions and the opinions as factors for the predicted ratings, the explicit feedback collaborative analysis model to update, for each of the users, the predicted ratings for each of the items.

8. The apparatus according to claim 7, wherein using the predicted ratings as the labels trains the sentiment analysis model, and wherein using the opinions as factors trains the explicit collaborative feedback model.

9. The apparatus according to claim 8, wherein the processor is further configured to repeat the steps of executing the sentiment analysis model and executing the explicit feedback collaborative filtering model until the opinions and the predicted ratings reach respective stable states.

10. The apparatus according to claim 8, wherein the transactions comprise first transactions, wherein the users comprise first users, wherein the items comprise first items, wherein the text strings comprise first text strings, wherein the opinions comprise first opinions, and wherein the processor is further configured to receive second transactions for a second user and a request for second opinions, each of the second transactions comprising the second user, a second item, and a second text string indicating an attitude of the second user about the second item, and to execute, using input comprising the second transactions, the trained sentiment analysis model to compute, in response to the request, a second opinion for each of the second items in the second transactions for the second user.

11. The apparatus according to claim 8, wherein the transactions comprise first transactions, wherein the users comprise first users, wherein the items comprise first items, wherein the text strings comprise first text strings, wherein the predicted ratings comprise first predicted ratings, and wherein the processor is further configured to receive second transactions for a second user and a request for second predicted ratings, each of the second transactions comprising the second user, a second item, and a second text string indicating an attitude of the second user about the second item, and to execute, using input comprising the second transactions, the trained explicit feedback collaborative analysis model to compute, in response to the request, respective second predicted ratings for each of the second items in the second transactions for the second user.

12. The apparatus according to claim 7, and wherein the processor is further configured to skip the performing of the implicit feedback collaborative filtering model, to compute, using a transfer learning algorithm, the labels for each of the text strings, and to convey the labels to the sentiment analysis.

13. A computer program product, the computer program product comprising:
a non-transitory computer readable storage medium having computer readable program code embodied therewith, the computer readable program code comprising:
computer readable program code configured to receive a set of transactions for multiple users, each of the transactions comprising a user, an item, and a text string indicating an attitude of the user toward the item;
computer readable program code configured to identify a set of the items in the transactions;
computer readable program code configured to execute, using input comprising the transactions, an implicit feedback collaborative filtering model to compute, for each of the users, a predicted rating for each of the items;
computer readable program code configured to execute, using input comprising the transactions and the predicted ratings as labels, a sentiment analysis model to compute, for each given user, an opinion for each of the given items in the transactions for the given user; and
computer readable program code configured to execute, using input comprising the transactions and the opinions as factors for the predicted ratings, an explicit feedback collaborative analysis model to update, for each of the users, the predicted ratings for each of the items.

14. The computer program product according to claim 13, wherein using the predicted ratings as the labels trains the sentiment analysis model, and wherein using the opinions as factors trains the explicit collaborative feedback model.

15. The computer program product according to claim 14, and further comprising computer readable program code configured to repeat the steps of executing the sentiment analysis model and executing the explicit feedback collaborative filtering model until the opinions and the predicted ratings reach respective stable states.

16. The computer program product according to claim 14, wherein the transactions comprise first transactions, wherein the users comprise first users, wherein the items comprise first items, wherein the text strings comprise first text strings, wherein the opinions comprise first opinions, and further comprising computer readable program code configured to receive second transactions for a second user and a request for second opinions, each of the second transactions comprising the second user, a second item, and a second text string indicating an attitude of the second user about the second item, and to execute, using input comprising the second transactions, the trained sentiment analysis model to compute, in response to the request, a second opinion for each of the second items in the second transactions for the second user.

17. The computer program product according to claim 14, wherein the transactions comprise first transactions, wherein the users comprise first users, wherein the items comprise first items, wherein the text strings comprise first text strings, wherein the predicted ratings comprise first predicted ratings, and further comprising computer readable program code configured to receive second transactions for a second user and a request for second predicted ratings, each of the second transactions comprising the second user, a second item, and a second text string indicating an attitude of the second user about the second item, and to execute, using input comprising the second transactions, the trained explicit feedback collaborative analysis model to compute, in response to the request, respective second predicted ratings for each of the given items in the second transactions for the second user.

18. The computer program product according to claim 13, and further comprising computer readable program code configured to skip the performing of the implicit feedback collaborative filtering model, to compute, using a transfer learning algorithm, the labels for each of the text strings, and to convey the labels to the sentiment analysis.
